(19) United States
(12) Patent Application Publication
(10) Pub. No.: US 2025/0325352 A1
(43) Pub. Date: Oct. 23, 2025

(54) DENTAL IMPLANT STRUCTURE FOR PREVENTING THE UPPER STRUCTURE OF DENTAL IMPLANTS FROM SINK-ING AND PREVENTING THE ABLATION SCREW FROM LOOSENING

(71) Applicant: Hee Jin CHAE, Yangsan-si (KR)

(72) Inventors: Hee Jin CHAE, Yangsan-si (KR); Sung Ki CHAE, Yangsan-si (KR)

(21) Appl. No.: 19/082,891

(22) Filed: Mar. 18, 2025

Related U.S. Application Data
(63) Continuation of application No. PCT/KR2023/016212, filed on Oct. 19, 2023.

(30) Foreign Application Priority Data
Oct. 21, 2022 (KR) 10-2022-0136793

(51) Int. Cl. A61C 8/00

(52) U.S. Cl. CPC A61C 8/0069; A61C 2008/0084

(57) ABSTRACT

The present invention relates to a dental implant structure for preventing the sinking of the dental implant superstructure and preventing the loosening of the abutment screw, and in particular, relates to a dental implant structure for preventing the sinking of the dental implant superstructure and preventing the loosening of the abutment screw that, by ensuring that the abutment and the connection screw section are fastened without a gap, prevents a distorting phenomenon of the abutment's interior, despite repeated chewing. In the present invention, since the abutment and the inside of the abutment are each formed in a tapered shape and the connection screw section is fastened to the abutment without a gap between the two when the connection screw section is fastened, the distorting phenomenon of the inside of the abutment can be prevented, even with repeated chewing. Moreover, since the abutment and the inside of the abutment are each formed in a tapered shape, the loosening phenomenon of the connection screw is minimized, even with repeated chewing.

### REFERENCE TO RELATED APPLICATIONS

This is a continuation of International Patent Application PCT/KR2023/016212 filed on Oct. 19, 2023, which designates the United States and claims priority of Korean Patent Application No. 10-2022-0136793 filed on Oct. 21, 2022, the entire contents of which are incorporated herein by reference.

### FIELD OF THE INVENTION

The present invention relates to a dental implant structure for preventing the sinking of the dental implant superstructure and preventing the loosening of the abutment screw, and in particular, relates to a dental implant structure for preventing the sinking of the dental implant superstructure and preventing the loosening of the abutment screw that, by ensuring that the abutment and the connection screw section are fastened without a gap, prevents a distorting phenomenon of the abutment's interior, despite repeated chewing.

### BACKGROUND OF THE INVENTION

The implant comprises a prosthesis (crown) that functions as a tooth, an abutment that connects the artificial tooth root and crown, and an artificial tooth root (fixture) that functions as the tooth root.

The artificial tooth root and abutment function to wholly support the implant, and are usually connected in the form of a screw so that they can be firmly connected.

However, when the abutment screw and the abutment are connected, due to two structural problems, a gap occurs between the two.

Due to this gap, as repetitive chewing is performed, the gap between the abutment screw and the abutment causes the abutment to sink downward as it distorts inward, resulting in the abutment screw becoming loose. As such, if repeated chewing is performed after the abutment screw has loosened, the abutment screw may fracture, causing the problem of the entire implant's needing to be replaced.
(Patent Documentation 1) Korean Patent Registration Gazette No. 10-1067668 (2011.09.20)
(Patent Documentation 2) Korean Patent Registration Gazette No. 10-2313748 (2021.10.12)

### SUMMARY OF THE INVENTION

The purpose of the present invention is to prevent the inside of the abutment from becoming distorted even by repeated chewing by forming the abutment and the inside of the abutment each in a tapered shape, and when the connection screw section is fastened to the abutment, by fastening the connection screw section without a gap between the two.

Moreover, the purpose includes minimizing a loosening phenomenon of the connection screw even with repeated chewing by forming the abutment and the inside of the abutment each in a tapered shape.

To solve the aforementioned problem, the present invention provides a dental implant structure that includes a fixture (100) having an outer surface formed in a screw thread shape while having an accommodating groove (110) formed to accommodate an abutment (200) and a connection screw section (300), an abutment (200) to be fastened to the accommodating groove (110) of the aforementioned fixture (100), and a connection screw section (300) formed to be fastened by penetrating through the through hole (210) of the aforementioned abutment (200) and whose lower end is accommodated by and fastened to the accommodating groove (110) of the fixture (100); the aforementioned accommodating groove (110) is formed as a screw thread on one side, and is formed in a shape corresponding to the screw thread of the fastening screw section (320) so that the fastening screw section (320) of the connection screw section (300) is accommodated and connected; the aforementioned abutment (200) includes a through hole (210) having a predetermined size for the connection screw section (300) to penetrate and be fastened, a 1st finished surface (220) formed by cutting on one side of the outer surface of the aforementioned abutment (200), and a fastening section (230) formed on one side of the lower portion of the aforementioned abutment (200) and formed in a polygonal shape to prevent rotation when fastened to the fixture (100); the aforementioned through hole (210) includes a 1st through hole (211) formed as a through hole of a predetermined length and having a sufficient size for the connection screw section (300) to penetrate, with one side of the aforementioned through hole (210) including the 1st tapered section (212) formed in a tapered shape with a diameter that decreases in the direction from the 1st through hole (211) to the 2nd through hole (213), and the 2nd through hole (213) formed by being connected to the bottom of the 1st tapered section (212) and having a predetermined length while having the same diameter as the bottom diameter of the 1st tapered section (212); when the connection screw section (300) is fastened to the aforementioned abutment (200), the 1st tapered section (212) and the 2nd tapered section (310) are formed with corresponding sizes so that the 2nd tapered section (310) of the connection screw section (300) is fitted into the 1st tapered section (212) of the abutment (200), and the aforementioned 1st tapered portion (212) is characterized by forming at least at one of the positions between the position of being inserted into the gum or the position protruding by a predetermined length after being inserted into the gum; the aforementioned connection screw section (300) includes the 2nd tapered section (310) that is formed so that one side of the connection screw section (300) becomes narrower in diameter from top to bottom, the fastening screw section (320) that is formed as a screw thread to be connected to the accommodating groove (110) of the fixture (100), and the mechanism-fastening groove (330) that is formed at the top while a groove of a predetermined size is formed so that a turning mechanism is fastened to fasten the connection screw section (300) to the abutment (200), while formed to have a diameter smaller than that of the 2nd through hole (213) of the abutment (200); and when line segment I1 is drawn along the diameter of the top of the 1st tapered section (212), line segment I2 is formed perpendicular to I1 by extending from one end point of the top of the 1st tapered section (212), point k is created where I1 and I2 meet, and line segment I3 is formed by passing through point k while extending from the top to the bottom of the 1st tapered section (212), characterized by the value of the angle n formed by line segment I2, point k, and line segment I3 being 8 to 15 degrees) (°).

In the present invention, since the abutment and the inside of the abutment are each formed in a tapered shape and the connection screw section is fastened to the abutment without a gap between the two when the connection screw section is fastened, the distorting phenomenon of the inside of the abutment can be prevented, even with repeated chewing. Moreover, since the abutment and the inside of the abutment are each formed in a tapered shape, the loosening phenomenon of the connection screw is minimized, even with repeated chewing.

### BRIEF DESCRIPTION OF THE DRAWINGS

FIG. 1 shows the overall appearance of the present invention's implant.

FIG. 2 is an exploded view of FIG. 1.

FIG. 3 is a cross-sectional view of the present invention's implant, showing a crown included on the upper portion.

FIGS. 4A and 4B are figures showing the appearance of the connection between the present invention's abutment and connection screw section.

FIGS. 5A and 5B are figures of the present invention's abutment.

FIGS. 6A and 6B are figures of the present invention's connection screw section.

FIG. 7 is a figure of the present invention's custom abutment and connection screw section.

FIG. 8 is a cross-sectional view of the present invention's custom abutment and connection screw section.

FIG. 9 is a figure of the present invention's custom abutment.

FIG. 10 is a cross-sectional view of the present invention's custom abutment.

FIG. 11 is a figure showing the appearance of the present invention's connection screw section's fastening to the angle abutment.

FIGS. 12A and 12B are figures showing the separation of the angle abutment and the connection screw section.

FIG. 13 is a figure showing the interior projected when the angle abutment and the connection screw section are connected.

FIG. 14 is a figure showing the appearance of the present invention's connection screw section's fastening to the internal abutment.

FIGS. 15A and 15B are figures showing the separation of the internal abutment and the connection screw section.

FIG. 16 is a figure showing the interior projected when the internal abutment and the connection screw section are connected.

### DETAILED DESCRIPTION OF THE INVENTION

The terms or words used in this specification and its scope of claims should not be interpreted as limited to their usual or dictionary meanings, but should be construed as having meanings and concepts that conform to the present invention's technical idea, based on the principle that the inventor may appropriately define the concepts of terms in order to explain their invention in the best possible way.

Hereinafter, the present invention's preferred embodiment shall be described in detail with reference to the accompanying figures.

The present invention relates to a dental implant structure, and in particular, to an implant structure that, by ensuring that its abutment and its connecting screw section are fastened without a gap when fastened together, prevents the inside of an abutment from becoming distorted, even with repeated chewing.

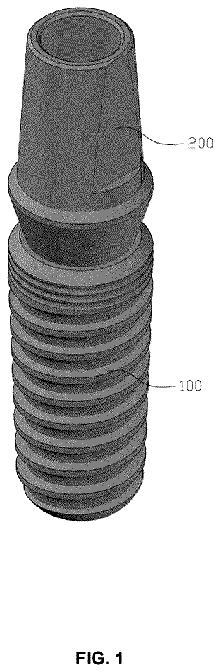

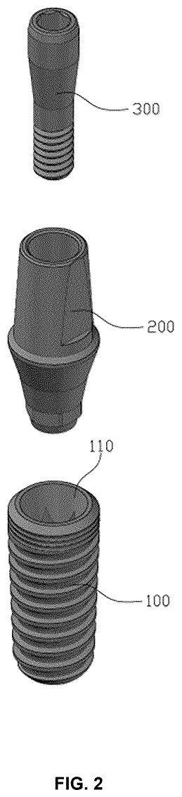

FIG. 1 is a figure showing the overall appearance of the present invention's implant, while FIG. 2 is an exploded view of FIG. 1; in reference to this, the present invention's implant structure's invention is configured to include a fixture (100), an abutment (200), and a connection screw section (300).

Each component is described in detail as follows:

The fixture (100) has an outer surface formed in a screw thread shape while having an accommodating groove (110) formed to accommodate the abutment (200) and the connection screw section (300).

The aforementioned accommodating groove (110) is formed as a screw thread on one side, and is formed in a shape corresponding to the screw thread of the fastening screw section (320) so that the fastening screw section (320) of the connection screw section (300) is accommodated and connected.

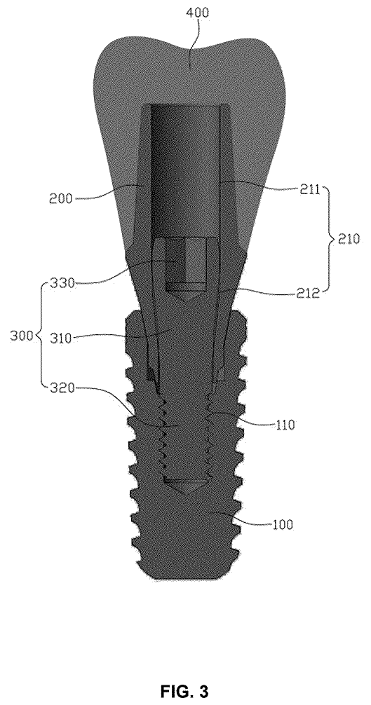

FIG. 3 is a cross-sectional view of the present invention's implant, showing a crown included on the upper portion.

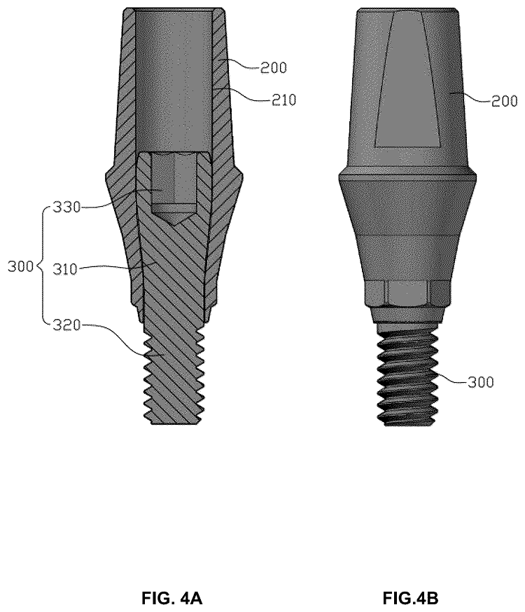

FIG. 4 is a figure showing the appearance of the connection between the present invention's abutment and connection screw section.

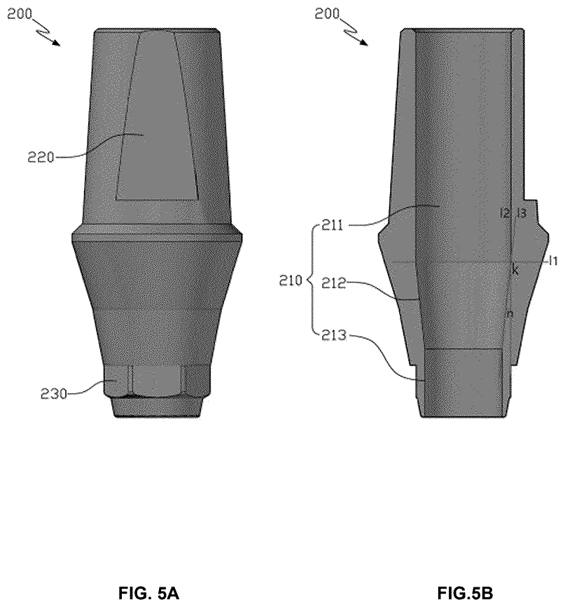

FIG. 5 relates to the present invention's abutment.

Referring to FIG. 1 to FIG. 5, the abutment (200) is intended to be fastened to the accommodating groove (110) of the aforementioned fixture (100).

The aforementioned abutment (200) is configured to include a through hole (210), a 1st finished surface (220), and a fastening section (230).

The through hole (210) is formed as a through hole of a predetermined size for the connection screw section (300) to penetrate and be fastened.

The aforementioned through hole (210) consists of a 1st through hole (211), a 1st tapered section (212), and a 2nd through hole (213).

The 1st through hole (211) is formed as a through hole of a predetermined length and has a sufficient size for the connection screw section (300) to penetrate.

The 1st tapered section (212) is positioned in between the 1st through hole (211) and the 2nd through hole (213) while being formed in a tapered shape with a diameter that decreases in the direction from the 1st through hole (211) to the 2nd through hole (213).

The 2nd tapered section (310) of the connection screw section (300) is fitted into the aforementioned 1st tapered section (212), and when the abutment (200) and the connection screw section (300) are connected, there is no space between the 1st tapered section (212) of the abutment (200) and the 2nd tapered section (310) of the connection screw section (300).

Moreover, the aforementioned 1st tapered section (212) preferably should be formed at least at one of the positions between the position of being inserted into the gum or the position protruding by a predetermined length after being inserted into the gum, to enable the prevention of the abutment (200) from becoming distorted due to repeated chewing activity after implant placement.

Referring to FIG. 5B, when line segment I1 is drawn along the diameter of the top of the 1st tapered section (212),
line segment I2 is formed perpendicular to I1 by extending from one end point of the top of the 1st tapered section (212),
point k is created where I1 and I2 meet, and
line segment I3 is formed by passing through point k while extending from the top to the bottom of the 1st tapered section (212),
the value of the angle n formed by line segment I2, point k, and line segment I3 is characterized by being 8 to 15 degrees (°), while preferably being 12 degrees (°).

The 2nd through hole (213) is formed by being connected to the bottom of the 1st tapered section (212) and having a predetermined length while having the same diameter as the bottom diameter of the 1st tapered section (212).

The 1st finished surface (220) is formed by cutting on one side of the outer surface of the aforementioned abutment (200).

The fastening section (230) is formed on one side of the lower portion of the aforementioned abutment (200) while being formed in a polygonal shape to prevent rotation when fastened to the fixture (100).

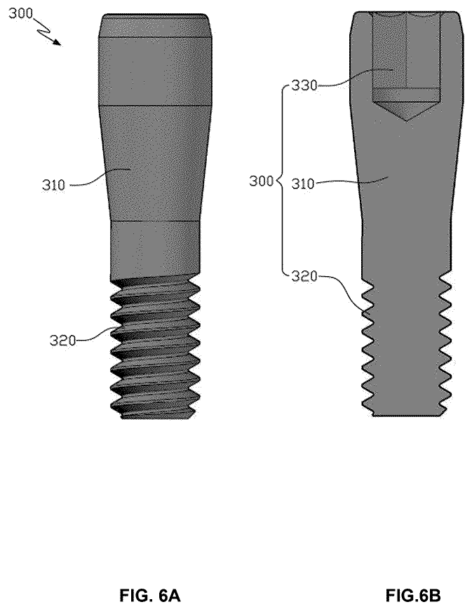

FIG. 6 is a figure of the present invention's connection screw section (300).

The connection screw section (300) is formed to be fastened by penetrating the aforementioned abutment (200) and its lower end is accommodated by and fastened to the accommodating groove (110) of the fixture (100).

The aforementioned connection screw section (300) is configured to include a 2nd tapered section (310), a fastening screw section (320), and a mechanism-fastening groove (330).

The 2nd tapered section (310) is formed to narrow the diameter from top to bottom. The aforementioned 2nd tapered section (310) is formed with a size corresponding to the 1st tapered section (212), and when the connection screw section (300) is fastened to the abutment (200), the 2nd tapered section is accommodated to the 1st tapered section (212) so that there is no space in the connection between the two.

The fastening screw section (320) is formed as a screw thread and as shown in FIG. 3, is intended to be connected to the accommodating groove (110) of the fixture (100).

The mechanism-fastening groove (330) is formed at the top while a groove of a predetermined size is formed so that a turning mechanism is fastened to fasten the connection screw section (300) to the abutment (200).

The aforementioned mechanism-fastening groove (330) is formed by extending along the bottom of the 2nd tapered section (310) and preferably should be formed to have a diameter smaller than that of the 2nd through hole (213) of the abutment (200) to facilitate smooth penetration.

The crown (400) is formed on top of the aforementioned abutment (200).

In FIG. 3, it can be seen that the crown (400) is formed on the upper portion of the abutment (200).

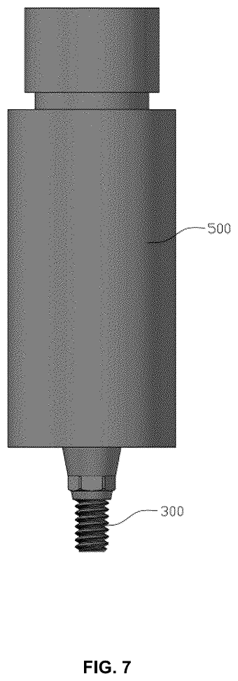

FIG. 7 is a figure of the present invention's custom abutment and connection screw section.

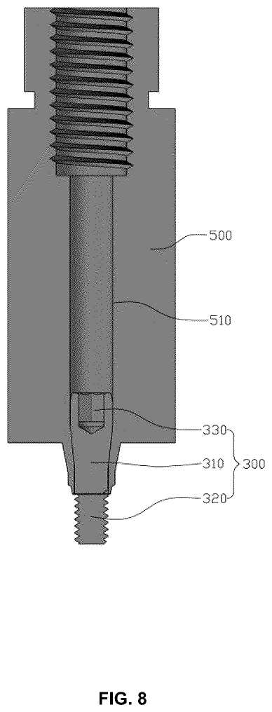

FIG. 8 is a cross-sectional view of the present invention's custom abutment and connection screw section.

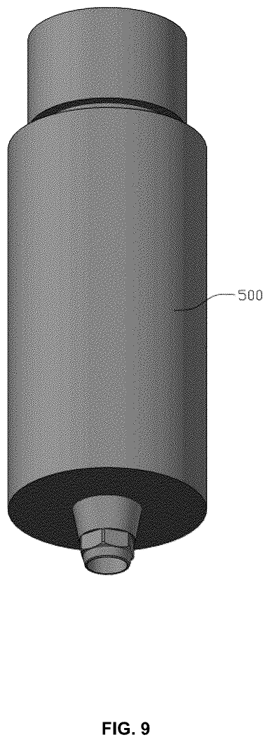

FIG. 9 is a figure of the present invention's custom abutment.

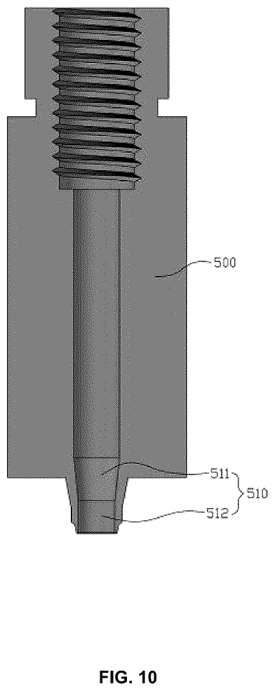

FIG. 10 is a cross-sectional view of the present invention's custom abutment.

The custom abutment (500) has the 1st connection screw fastening hole (510) formed on one side through which the connection screw section (300) is penetrated and fastened.

The aforementioned custom abutment (500) may be used in place of the abutment (200), and a connection screw part (300) may be penetrated and fastened into the custom abutment (500).

The 1st connection screw fastening hole (510) is configured to include a 3rd tapered section (511) and a 3rd through hole (512).

The 3rd tapered section (511) is formed so that its diameter becomes narrower from top to bottom and is formed in a shape corresponding to the 2nd tapered section (310) of the connection screw section (300).

In other words, when the connection screw section (300) is fastened to the aforementioned custom abutment (500), the 3rd tapered section (511) and the 2nd tapered section (310) preferably should be formed to be equal in size so that the 2nd tapered section (310) of the connection screw section (300) fits into the 3rd tapered section (511) of the custom abutment (500).

The 3rd through hole (512) is a hole that is formed by extending the bottom of the aforementioned 3rd tapered section (511) and is formed with the same diameter as the bottom diameter of the 3rd tapered section (511).

Moreover, the 3rd through hole (512) preferably should be formed to have a larger diameter than the section formed by extending along the bottom of the 2nd tapered section (310) of the connection screw section (300).

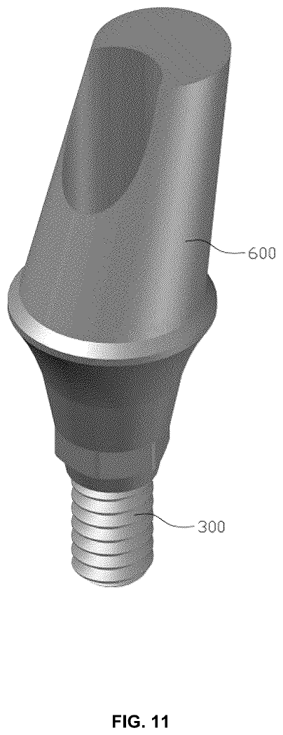

FIG. 11 to FIG. 13 are figures showing the appearance of the interior of the angled abutment (600) applied to apply the present invention's connection screw section (300), and deformed into a shape corresponding to the connection screw section (300).

FIG. 11 is a figure showing the appearance in which the present invention's connection screw section is fastened to the angled abutment.

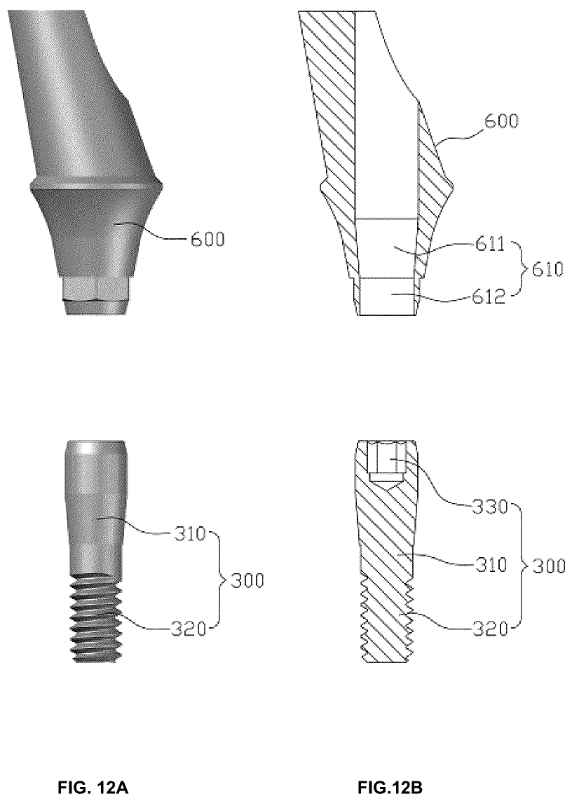

FIG. 12 is a figure showing the appearance in which the angled abutment and the connecting screw are separated.

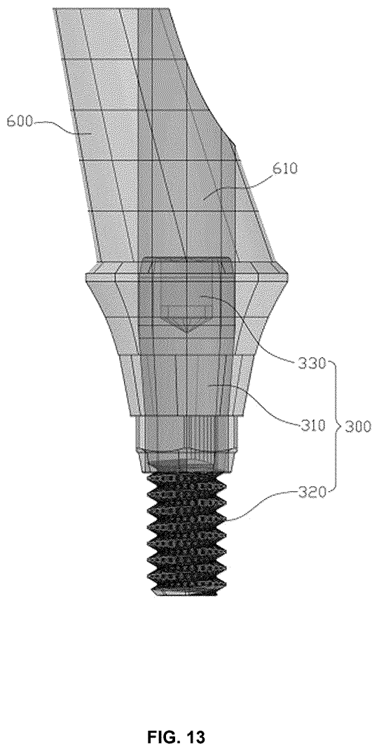

FIG. 13 is a figure showing the appearance of the interior projected, with the angled abutment and the connecting screw section connected.

Through FIG. 11 to FIG. 13, it can be seen that the angled abutment (600) is formed in a shape in which one upper side is slanted, and that the 2nd connection screw fastening hole (610) is formed so that the connection screw section (300) is accommodated and fastened.

The aforementioned connection screw fastening hole (610) is configured to include a 4th tapered section (611) and a 4th through hole (612).

The 4th tapered section (611) is formed so that its diameter narrows from top to bottom and is formed in a shape corresponding to the 2nd tapered section (310) of the connection screw section (300).

In other words, when the connection screw section (300) is fastened to the aforementioned angled abutment (600), the 4th tapered section (611) and the 2nd tapered section (310) preferably should be formed to be equal in size so that the 2nd tapered section (310) of the connection screw section (300) fits into the 4th tapered section (611) of the angled abutment (600).

The 4th through hole (612) is a hole that is formed by extending the bottom of the aforementioned 4th tapered section (611) and is formed with the same diameter as the bottom diameter of the 4th tapered section (611).

Moreover, the 4th through hole (612) preferably should be formed to have a larger diameter than the section formed by extending along the bottom of the 2nd tapered section (310) of the connection screw section (300).

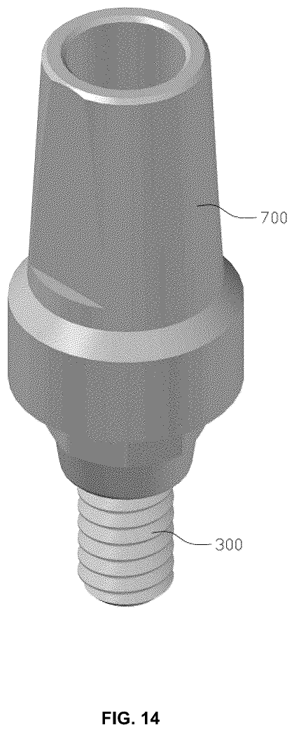

FIG. 14 to FIG. 16 are figures showing the appearance of the interior of the internal abutment (700) applied to apply the present invention's connection screw section (300), and deformed into a shape corresponding to the connection screw section (300).

FIG. 14 is a figure showing the appearance of the present invention's connection screw section's fastening to the internal abutment.

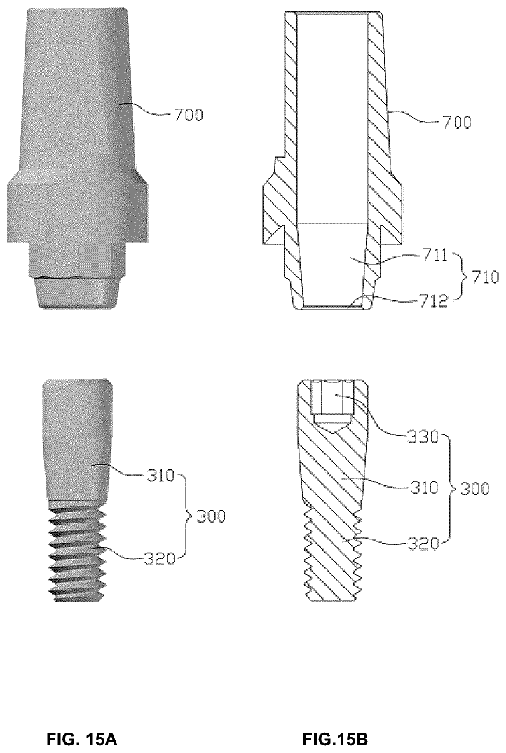

FIG. 15 is a figure showing the separation of the internal abutment and the connection screw section.

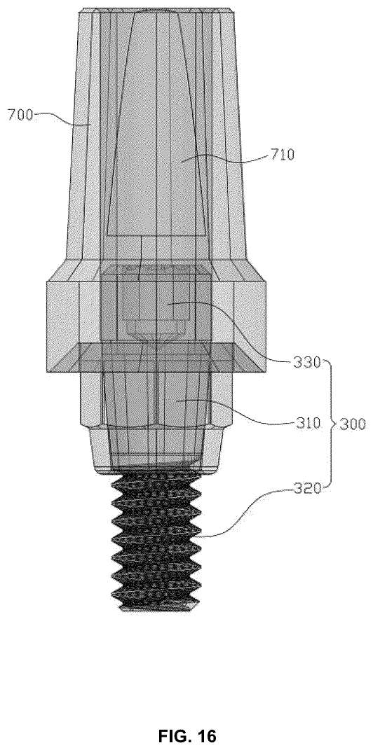

FIG. 16 is a figure showing the interior projected when the internal abutment and the connection screw section are connected.

Referring to FIG. 14 to FIG. 16, the internal abutment (700) is for connecting to the interior of the fixture, and to accommodate and fasten the connection screw section (300), a 3rd connection screw fastening hole (710) is formed.

The aforementioned 3rd connection screw fastening hole (710) is configured to include a 5th tapered section (711) and a 5th through hole (712).

The 5th tapered section (711) is formed so that its diameter narrows from top to bottom and is formed in a shape corresponding to the 2nd tapered section (310) of the connection screw section (300).

In other words, when the connection screw section (300) is fastened to the aforementioned internal abutment (700), the 5th tapered section (711) and the 2nd tapered section (310) preferably should be formed to be equal in size so that the 2nd tapered section (310) of the connection screw section (300) fits into the 5th tapered section (711) of the internal abutment (700).

The 5th through hole (712) is a hole that is formed by extending the bottom of the aforementioned 5th tapered section (711) and is formed with the same diameter as the bottom diameter of the 5th tapered section (711).

Moreover, the 5th through hole (712) preferably should be formed to have a larger diameter than the section formed by extending along the bottom of the 2nd tapered section (310) of the connection screw section (300).

Indeed as such, the present invention may modify the internal structure of various other abutments into a structure to which the connecting screw section (300) may be fastened.

The embodiments described in this specification and the configurations illustrated in these figures represent only the present invention's most preferred embodiments and do not speak for all of the present invention's technical ideas. Therefore, it should be understood that there may be various equivalents and modified examples that can replace them.

[SYMBOL KEY]

| | |
|---|---|
| 100 | Fixture |
| 110 | Accommodating groove |
| 200 | Abutment |
| 210 | Through hole |
| 211 | 1st through hole |
| 212 | 1st tapered section |
| 213 | 2nd through hole |
| 220 | 1st finished surface |
| 230 | Fastening section |
| 300 | Connection screw section |
| 310 | 2nd tapered section |
| 320 | Fastening screw section |
| 330 | Mechanism-fastening groove |
| 400 | Crown |
| 500 | Custom abutment |
| 510 | 1st connection screw fastening hole |
| 511 | 3rd tapered section |
| 512 | 3rd through hole |
| 600 | Angled abutment |
| 610 | 2nd connection screw fastening hole |
| 611 | 4th tapered section |
| 612 | 4th through hole |
| 700 | Internal abutment |
| 710 | 3rd connection screw fastening hole |
| 711 | 5th tapered section |
| 712 | 5th through hole |

What is claimed is:

1. A dental implant comprising:
a fixture (100) having an outer surface formed in a screw thread shape while having an accommodating groove (110) formed in an axial direction;
an abutment (200) to be fastened to the accommodating groove (110) of the aforementioned fixture (100); and
a connection screw section (300) formed to be fastened by penetrating through an axial through hole (210) of the aforementioned abutment (200) and whose lower end is accommodated by and fastened to the accommodating groove (110) of the fixture (100);
wherein the aforementioned accommodating groove (110) is formed as a screw thread on one side, and is formed in a shape corresponding to the screw thread of the fastening screw section (320) so that the fastening screw section (320) of the connection screw section (300) is accommodated and connected;
wherein the aforementioned abutment (200) includes:
a through hole (210) having a predetermined size for the connection screw section (300) to penetrate and be fastened;
a 1st finished surface (220) formed by cutting on one side of the outer surface of the aforementioned abutment (200); and
a fastening section (230) formed on one side of the lower portion of the aforementioned abutment (200) and formed in a polygonal shape to prevent rotation when fastened to the fixture (100);
wherein the aforementioned through hole (210) includes:
a 1st through hole (211) formed as a through hole of a predetermined length and having a sufficient size for the connection screw section (300) to penetrate, with one side of the aforementioned through hole (210) including the 1st tapered section (212) formed in a tapered shape with a diameter that decreases in the direction from the 1st through hole (211) to the 2nd through hole (213); and
the 2nd through hole (213) formed by being connected to the bottom of the 1st tapered section (212) and having a predetermined length while having the same diameter as the bottom diameter of the 1st tapered section (212);
when the connection screw section (300) is fastened to the aforementioned abutment (200), the 1st tapered section (212) and the 2nd tapered section (310) are formed with corresponding sizes so that the 2nd tapered section (310) of the connection screw section (300) is fitted into the 1st tapered section (212) of the abutment (200), and
wherein the aforementioned 1st tapered portion (212) is characterized by forming at least at one of the positions between the position of being inserted into the gum or the position protruding by a predetermined length after being inserted into the gum;
wherein the aforementioned connection screw section (300) includes:
the 2nd tapered section (310) that is formed so that one side of the connection screw section (300) becomes narrower in diameter from top to bottom,
the fastening screw section (320) that is formed as a screw thread to be connected to the accommodating groove (110) of the fixture (100); and
the mechanism-fastening groove (330) that is formed at the top while a groove of a predetermined size is formed so that a turning mechanism is fastened to fasten the connection screw section (300) to the abutment (200), while formed to have a diameter smaller than that of the 2nd through hole (213) of the abutment (200); and
when line segment I1 is drawn along the diameter of the top of the 1st tapered section (212),
line segment I2 is formed perpendicular to I1 by extending from one end point of the top of the 1st tapered section (212),
point k is created where I1 and I2 meet, and
line segment I3 is formed by passing through point k while extending from the top to the bottom of the 1st tapered section (212),
characterized by the value of the angle n formed by line segment I2, point k, and line segment I3 being 8 to 15 degrees (°).
